(19) United States
(12) Patent Application Publication
(10) Pub. No.: US 2026/0277995 A1
(43) Pub. Date: Sep. 17, 2026

(54) SYSTEM FOR MULTIFACETED SEARCHES OF SENSOR DATA

(71) Applicant: Roboto Technologies, Inc., Seattle, WA (US)

(72) Inventors: Benjamin Jack Barash, Seattle, WA (US); Yves Albers-Schoenberg, Seattle, WA (US)

(21) Appl. No.: 19/167,530

(22) PCT Filed: Mar. 21, 2024
(86) PCT No.: PCT/US24/20890

§ 371 Date: Sep. 22, 2025

Related U.S. Application Data
(60) Provisional application No. 63/491,472, filed on Mar. 21, 2023.

(51) Int. Cl. G06F 16/58; G06F 16/535

(52) U.S. Cl. CPC G06F 16/5866; G06F 16/535

(57) ABSTRACT

Systems and methods directed to, among other things, processing, searching, and storing sensor data are presented. Queries for data searches may be multifaceted in that data of one or more sensor types may be searched per a combination of conditions or parameters. Sensor data may be queried and searched using various types of user interfaces and techniques. In various implementations, a user may present a search query that is a logical combination of sensor types and/or conditions. The end-user may form and/or present the query via a command-line interface (CLI-based) utility or a natural language processing (NLP) utility. The latter may allow for system interaction using an intelligent chatbot to perform searches, visualize, and transform sensor data.

### CROSS REFERENCE TO RELATED APPLICATIONS

This application is a 371 filing of International Patent Application No. PCT/US24/20890, entitled, “SYSTEM FOR MULTIFACETED SEARCHES OF SENSOR DATA,” filed Mar. 21, 2024, which claims priority and benefit from the U.S. Provisional Patent Application 63/491,472, filed Mar. 21, 2023 and titled, “SYSTEM FOR MULTIFACETED SEARCHES OF SENSOR DATA,” which are incorporated herein by reference in their entirety for all purposes.

### BACKGROUND

Modern robotic systems such as drones, self-driving cars, aircraft, and mechanical arms make use of dozens of sensors to perceive the world and determine how to complete a task or achieve a goal. There are many types of sensors that these systems use, including optical sensors (e.g., cameras, lidars), inertial measurement units (IMUs), and sensors for measuring temperature, pressure, humidity, force, and vibration, just to name a few examples. These sensors can produce large volumes of data at respective frequencies that differ from one another. For example, a camera of a system may produce images at 10 Hz whereas an IMU of the system may produce measurements at 500 Hz. When the system fails, this sensor data must be analyzed to help determine root cause(s) for the failure and how widespread a failure mode may be. Unfortunately, given the high volume and complexity of the data, its analysis is often a slow and challenging process.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is an example embodiment of sensor data comprising an image that includes image objects.

FIG. 2 is an example embodiment of a data field or a user interface window that includes drop-down menus for user selection of parameters for a search query.

FIG. 3 illustrates geographic data on a map that includes a path of a drone, according to some embodiments.

FIG. 4 illustrates altitude data on a graph for a path of a drone, according to some embodiments.

FIG. 5 illustrates an example point cloud from a lidar, according to some embodiments.

FIG. 6 illustrates non-optical data on a graph that may be used with a chatbot style user interface for querying sensor data, according to some embodiments.

FIG. 7 includes images used in an example of a chatbot style user interface for querying sensor data, according to some embodiments.

FIG. 8 illustrates a process of selecting a portion of a data plot in a graph for a search query, according to some embodiments.

FIG. 9 is a block diagram depicting a computing device, according to some embodiments.

FIG. 10 is a block diagram of an example machine learning system.

FIG. 11 is a block diagram of example machine learning models.

FIG. 12 is a flow diagram of a process for a data search, according to some embodiments.

FIG. 13 is a flow diagram of another process for a data search, according to some embodiments.

### DETAILED DESCRIPTION

This disclosure describes architectures and methods directed to, among other things, processing, searching, and storing sensor data. Queries for data searches may be multifaceted in that data of one or more sensor types may be searched per a combination of conditions or parameters, as described below.

Systems such as robots, drones, self-driving cars, and mechanical (robotic) arms/end-effectors often use multiple sensors to perceive their operating environment. Other types of systems, such as various vehicles (e.g., aircraft, watercraft, spacecraft) or other moveable objects, conveyors, industrial manufacturing apparatus, field stations (e.g., weather-measuring instruments), etc., may likely also use one or more sensors. Additionally, there are systems that operate with artificial intelligence (AI) processes that use a relatively large amount of sensor data. Upon failure (or success) of such systems, collected sensor data may be used by an AI model in a process of machine learning.

Generally, sensor information (e.g., data) may be used to determine how to complete a task or achieve a goal. Archived (e.g., stored in a database) sensor information may be used in an investigative manner to determine conditions that were present for an event, such as a failure. For example, autonomous vehicles operate based on AI, which uses multiple real-time sensor input. Such vehicles must be operated with high degrees of safety and reliability. In a failure event, sensor data collected just before, during, and after the event may be investigated to understand how or why such a failure occurred. Such an investigation may begin with a judicious search through the relatively large amount of sensor data. Embodiments described herein may allow for efficient and powerful data searches, “powerful” in the sense that searches may combine different types of data, parameters, and conditions so that search results may be focused on what a searcher (e.g., investigator) believes are the most important conditions present during the event.

There are many types of sensors that systems use. Some examples are optical sensors (such as cameras (single frame or video frames), lidars, light intensity sensors, infrared (IR) sensors, etc.), inertial measurement units (IMU), temperature sensors, ultrasound, pressure and humidity sensors, force and vibration sensors, sound sensors, voltage/current sensors, etc. Herein, video and/or image frames (and the pixels and metadata thereof) are considered data produced by sensors, which may be cameras, video recorders, or other type of image capture device.

The following is a list of examples of types of data (e.g., parameters of a vehicle) that various sensors may measure for a vehicle: battery voltage level, brake, brake switch, gear position, left turn signal, rear left rpms, rear right rpms, right turn signal, steering, steering speed, throttle, vehicle speed, yaw rate.

Sensors, such as those listed above, may produce large volumes of data in relatively short times. Sensors may also produce large amounts of data resulting from operating times that are relatively long. Different sensors sensing the same environment at the same time may operate at frequencies different from one another. For example, a camera may produce images at 10 Hz, whereas an IMU may produce measurements at 500 Hz. Generally, different sensors of the same system may operate asynchronously with one another.

Relatively large amounts of data and asynchronicity among different sensors may be among a number of reasons why searching and utilizing sensor data may be a relatively difficult task. Thus, for example, when robotic systems fail, sensor data may be analyzed to help determine root cause of failure and how widespread the failure mode may be. However, given the volume and complexity of the sensor data, sensor data analysis may be a slow and challenging process. Example embodiments herein describe how sensor data may be efficiently queried.

In a particular example, if a drone had a battery voltage supply malfunction, an on-board voltage sensor signal may be represented graphically. Characteristics of the voltage sensor data set forth in this way may be selected and used to seed a query to find other drone flights that exhibited a same or similar issue. More than one sensor signal may be selected for complex queries. In embodiments herein, there need not be any limits to how many combinations of data may be included in a search. For example, a combination of sensor signals (e.g., battery voltage and temperature) may be important for an analysis of an event. Results from such queries and analysis may be used to answer questions like: How many times has this type of event occurred? What portion or subset of a fleet has been (or is) experiencing this type of event?

As mentioned above, many types of sensors may produce very large amounts of data. For example, machine vision cameras may produce ten or so images per second. Storing or archiving all such data would be inefficient and not practical if the hundreds or thousands of images captured by a camera never changed. Accordingly, embodiments herein describe techniques and methods that allow for reducing relatively large volumes of sensor data to more manageable and cost-efficient volumes. For example, a filtering method, such as downsampling, may be used. In an implementation, a system may automatically arrive at a sensible downsampling rate or facilitate a user-configured set of rates. For example, someone in a company may configure 10 Hz camera data to be downsampled to 5 Hz during an upload process. In another example, 500 Hz IMU data may be downsampled to 10 Hz. A user may also want to prioritize certain signals (e.g., data) to be uploaded first, having the remaining signals (e.g., data) uploaded afterward. In still another example of reducing relatively large volumes of sensor data to more manageable and cost-efficient volumes, when adding (e.g., archiving) new data to a dataset of historical sensor data, an automatic search may be performed to determine if any of the sensor signals have novel characteristics when compared to an existing corpus of data by using a similarity scoring process. Thus, if the new data is not sufficiently different from data already archived, it may be categorized as duplicative and moved to cheaper cold storage or deleted. In various implementations, archiving or storing may be limited to data that is relatively “unusual,” such as outlier data (e.g., data that lies an abnormal distance from expected or averaged values), and/or data associated (e.g., within a timespan) with outlier data. For example, if a relatively long time-series of voltage data includes a ten second span of unusual voltage values (as measured by a sensor (e.g., voltage meter)), then only that ten-second span of data, and perhaps thirty seconds of (bracketed) data just before and just after the ten-second span, may be archived and the remaining data discarded or stored elsewhere. Additionally, data provided by other sensors measured during that ten-second timespan, even though the data of the other sensors may be “normal-valued,” may also be archived with the voltage data. This process may be considered to be a process of selection for archiving based on an association with data of another sensor. In the previous example, this association is time (e.g., archive all data measured during an unusual event), but in other examples, the association may be another parameter, such as location, various sensor values, or type of event, just to name a few examples.

In some embodiments, a system, upon or after receiving data produced by one or more sensors, may process the data to a form that can be searched based on respective features of the data. For example, such processing may involve time synchronization by time-stamping the data from respective sensors based on a single time reference. If data from a first sensor is collected at a frequency that is lower than that of a second sensor, then the data from the first sensor, after processing, may include null values for times for which there is no first-sensor data corresponding to data values from the second sensor. In some implementations, the system may temporally match data of different sensors in a search. This may be performed by finding the closest-in-time data of one sensor to match time stamped data of another sensor. For example, many data values of a sensor may exist per one image frame. In some cases, the many data values may be averaged, or one or more of the data values measured closest to the time that the image was captured may be selected for results of a search.

The system may use any of a number of approaches when data is uploaded into the system. For example, for preparing to store data in a searchable data base, the system may process the data to create a way for searches to look for features that represent elements of a search query. Some approaches may involve vector embeddings or different libraries, for example, in a multimodal space to search for complex patterns in signals (e.g., time series of sensor data) and to search for similar patterns or features in other signals. During an automatic or a manual transfer to upload data, the system may calculate fingerprints or feature vector embeddings for different sensor data signals to create a representation of the embeddings, thus providing a way that the uploaded data can be searched.

In some embodiments, a system, upon or after receiving data produced by one or more sensors, may determine if data is annotated, time-stamped, or includes associated metadata. The system may process the received data by type, add labels or other annotation to the data, and store the processed data so it is searchable by techniques described herein, for example. The data that the system, as described herein, may receive includes archived sensor data, recorded data, measured data, historical data, and so on. Pre-processing and filtering data before upload to the system may beneficially reduce processing, storage, and query costs.

In some embodiments, a system may ingest and/or search timestamped system logs (e.g., console/debug logs) and associate these with sensor data. These logs may generally be semi-structured and textual in nature and may be produced by robotic systems (along with sensor data) and may also be used for investigations and/or debugging. In a platform of a system, system logs, as well as graphs, videos, etc., may be visualized. The system may then associate these in time (or location) with the sensor data. For example, clicking a particular line of a system log may highlight the closest data points in time on a graph, or pull up the closest frame of a video. And vice versa, clicking a point on a graph (or jumping to a video frame) may highlight the closest console log line. For example, a dataset page from a drone may illustrate geographic data on a map, altitude data on a graph, and system logs in a table. Clicking a geo marker on the map may resultantly show a red vertical line on all graphs at the corresponding timestamp and may highlight the closest log message in time. The same is true vice versa, such that clicking a log message may highlight the closest position (e.g., illustrated by a red dot) and graph point (e.g., a red line), and clicking on a graph may highlight the closest geo marker (e.g., red dot) and log message (e.g., blue highlight). A user may also leave a comment on a region of a graph by selecting the corresponding time range.

In some embodiments, a system may search sensor data based on a received query, which specifies respective features of the data of one or more sensors among the sensor data. The search may also combine sensor data with non-sensor data. Results of such searches may yield a subset of the data presented on a user interface such as a display device. For example, search results may be graphically presented on a time scale. Results may also be requested and returned through a backend API.

In some embodiments, an end-user of any of the systems described above may form a search query that is subsequently translated or processed to a format used by the system. In various implementations, the end-user may present a query that is a logical combination of sensor types and/or conditions. The end-user may form and/or present the query via a command-line interface (CLI-based) utility. For example, one example query may be a request to search (e.g., retrieve) voltage data and temperature data collected for temperatures below 32 degrees and voltages between 0.8 and 2.0 volts. Another example query may be a request to search sensor data of a fleet of autos that were driven with a steering wheel rotation speed that is greater than a particular value while brakes were simultaneously applied. Still another example query may be a request to search sensor data provided by complementary sensors in the same timeframe. For example, all video footage from a drone camera that coincided with a malfunction or event may be retrieved for better situational context and to form a new dataset. Yet another example query may be a request to search sensor data of an autonomous vehicle that was driven faster than a particular speed while pedestrians were within less than a 10-degree angle from a front-rear center axis of the vehicle. In the latter example, one sensor is a speedometer and the other sensor is an image-capturing device (e.g., a camera or video camera). Object recognition may be applied to images to detect (e.g., “sense”) various objects, such as pedestrians and their locations or positions relative to a reference point. (Though a reference point need not be used in cases where merely the presence or absence of an object, such as a person, in an image frame is significant.) For example, a processor, through object recognition and image processing of an image may determine that a person is less than a 10-degree angle from a car, and a person is greater than a 10-degree angle from the car and another car. Because the image includes at least one incident of the condition specified in the search query (e.g., an autonomous vehicle that was driven faster than a particular speed while pedestrians were within less than a 10-degree angle from a front-rear center axis of the vehicle), the image, or some representation thereof, may be provided to the user as a result of the search.

In addition to a user interface (e.g., a GUI) being used for initiating queries and getting results, an Application Programming Interface (API) or Command Line Interface (CLI) may be used. For example, an end-user may want to build on top of a GUI of a system by using APIs and CLIs to automate queries and fetch results via the system without necessarily needing to use the GUI of the system.

Though some examples of embodiments described herein involve a human (e.g., a user) performing a task, such as initiating a search query, claimed subject matter is not limited to human-oriented implementations. For example, in some embodiments, a computing system performing methods described herein may be highly proactive and not rely on manual user interaction (e.g., directly from a human). For example, instead of humans, artificial intelligence (AI) “agents” (e.g., “bots”) may perform searches of sensor data in an attempt to find interesting edge cases (e.g., situationally significant data or events, anomalies, etc.). Results of such AI-based searches may be presented to humans for further review and investigation. A particular example may be computer system (e.g., an agent) initiated data anomaly detection to support automated quality assurance workflows. The agent could be initially prompted by humans to explore known-problematic contexts. For example, such a prompt may be “come up with search queries where pedestrians might have gotten close to a car, and then run these and review the results for any outliers.” A further implementation may be for the agent to automatically derive its own prompt with such contexts and lines of investigation via intelligent (AI) reasoning.

In some embodiments, a search query may combine image data with sensor data. For example, a system may receive a request to search (and retrieve) all images captured during a particular event or sensor value range. Such a search may be for “all images captured while voltage dropped greater than 20% in less than one second.” Searches that involve images may specify a number of various parameters of the images or objects in the images, such as view angle, number and/or position of particular objects (e.g., pedestrians), and so on. An example search may be for “all images that include an object identified as a person with greater than a 90% confidence score.” Here, such a confidence score may be associated with an object recognition process of an image object in an image, as described below.

In some embodiments, a system may classify regions of images, video frames, or 3D point clouds for computer vision (e.g., deep learning algorithms) and generate and assign metadata to them. Any type of object, motion cues, or tracking information of objects may be used to generate metadata that can be used for queries. In some implementations, an end-user may provide their own annotations on images or point clouds, or the end-user may upload this kind of data and have the system annotate it automatically. Point cloud data generally relates to a collection of points in N-dimensional space. Camera depth sensors or time-of-flight sensors typically produce 2D point clouds while lidars typically produce 3D point clouds. Each point in a point cloud can have an associated distance, as well as intensity values which relate to the return strength/brightness of the beam (dependent on the surface reflecting it). These values can be colorized to visually identify regions/objects or gauge distances. Similar to how regions of objects get labeled or annotated in images, regions (or clusters) of points in a point cloud can be labeled or annotated with detections. It's also possible to create correspondences between objects detected in a “normal” 2D camera image with their 3D lidar counterpart (and vice versa). In some implementations, a user may want to search for an object or detection from point cloud data and/or image data. A user may also want to use the distance or intensity values (when available) to constrain the results of a search query, such as finding detections of cars in point cloud data where distance are less than X, for example. Being able to search for similar time-series signals or similar objects in images may also allow for extending capabilities of a system to enable similarity searches on clusters of points.

In another embodiment, the system may connect to a 3^{rd} party annotation or labeling provider, and enable a collection of images, video frames, or point clouds to be sent to the 3rd party (e.g., via an API). The resulting annotations or labels could then be returned to the system and associated with the original images, video frames, or point clouds for subsequent queries.

In addition to image data, searches may also involve radar or lidar data combined with other sensor data (e.g., search all radar data during a particular time range when temperature was below a threshold value).

In some implementations, an end-user may present a query that is a logical combination of sensor types and/or conditions and that also includes one or more non-sensor data parameters, such as geographical location, cost valuation, calculated or predicted parameters, user-provided shapes or plot parameters, various archived data related to the situation of interest, etc. Logical combinations of queries may include search commands such as AND, OR, NOT, NAND, NOR, and so on.

In various embodiments, a system may allow for proactive, instead of just reactive, approaches for training AI models. For example, the system may be able to partition data into subsets of data across many different sensor modalities (e.g., particular sensor values, sensor types, event conditions, etc.). Thus, for example, a search query or data partitioning may be based on certain types of data, within particular value ranges, and so on.

In some embodiments, a search query may be formed graphically. For example, an end-user may “mouse-over” a portion of a graph (or click and drag the portion to a separate window, for example) to select the portion as a particular shape (of the graph) that will be used in a query for searching data having a same or similar shape. A graph may also contain multiple signals. If so, a signal search may be performed across all of the signals and an intersection may be calculated. To illustrate by example, the end-user may select a section of data plotted in a graph that is a Gaussian-shaped section having a particular value for its full width at half maximum (FWHM). A query based on this selection may then search through archived data looking for any or all data series (e.g., time-series) that has the same or similar Gaussian-shape with the particular FWHM. In some implementations, an end-user may select a series of data or a section of a plotted graph by methods other than “mousing-over.” For example, non-graphical methods via a CLI/API may be used. For example, the end-user may select a beginning data point and an end data point to delineate a time-series of sensor data. Such a selection may be made by typing in data or time values or mouse “clicking” on those portions of a data plot. The end-user may select one or more parameters that quantify how similar a query shape must be to shapes discovered in a search for the pair to be considered equal or a match.

Graphical search queries may allow for searches of time-series data that involve extracting certain statistical features from the data. For example, a search may look for a particular graphical shape or fingerprint and such a search may extract statistical features from the time-series data. In some embodiments, an end-user may form a search query that specifies which object present in archived data they are interested in by drawing (or providing a sketch or drawing of) the object. The system may perform a search by matching (e.g., within thresholds or bounds) all archived objects with the end-user provided drawing.

In some embodiments, a particular shape selected from a portion of a graph may be named or labelled and used in future searches. This allows an end-user to, among other things, visualize data and label accordingly for searches. For example, the end-user may name or label the Gaussian-shape (or other more complex shape) with the particular FWHM described above as “voltage spike.” The end-user may save such a label for future use. Thus, the end-user may form subsequent searches that include the search element name “voltage spike.” In a particular example, such a query may be to search archived temperature data measured within 20 seconds before any or all occurrences of a “voltage spike.” In another example, a search query may be for “left turns,” wherein an end-user may “teach” a system the meaning of this designation. Subsequently, the system may be able to search for left turns by looking at steering wheel position data, image data, GPS tracking data, and so on.

In some embodiments, a system may monitor incoming (e.g., uploaded or provided by sensors in real time, etc.) data for preset conditions, which may be end-user named conditions. For example, a named condition may be “battery voltage malfunction.” The system may monitor (e.g., search) incoming data for this named (e.g., end-user defined) condition. In another example, referring to the Gaussian-shape described above as “voltage spike,” the system may monitor incoming data for any voltage spike that may occur.

In some embodiments, a system may allow for accumulating and/or transforming results of a query to allow for the results to be used in various applications. For example, the system may allow an end-user to save/download some or all of the search result data, convert the format/shape of the search result data, send the search result data to a separate tool or application, and so on. In some embodiments, a system may provide various ways an end-user may i) manage their data, ii) interact with various databases (regardless of who or what collected the data in the databases), and iii) query various databases (or other forms of stored data). For example, the system may allow the end-user to place images or graphs into reports, produce collections of graphs and place into a report, and seed another search with results of a prior search, just to name a few examples.

In some embodiments, a system may use natural language processing (NLP) to search sensor data. For example, an end-user may type the following into a search box: “Find images where vehicle speed was greater than 35mph and people were detected in the center of the front camera.” The system may use NLP to convert such a search query into a form that the system can use to perform the search. For example, the system may use a large language model (e.g., GPT-3) with sufficient prompting and finetuning to translate the end-user formed natural language query into a structured SQL statement (e.g., of a Structured Query Language (SQL)). This process may occur without interaction with, or visibility to, the end-user. The system may then use the SQL statement to perform a multi-modal search in a database of the system. The large language model may provide flexibility and potential robustness. For example, if an end-user queries for “People crossing a street” or “Pedestrian crossing a street”, but the system only has objects called “Person” in its database, the model may choose the closest noun that matches an available object (e.g., “people,” “pedestrian,” “person” are essentially the same entity).

In some embodiments, a system may search and/or transform sensor data with natural language in the form of a chat (or chatbot-style) interface. For example, the chatbot may be interactive, so a user may ask a question/query and then continue to refine or transform the results through subsequent interactions. In various implementations, NLP-oriented capabilities may include supporting natural language queries and interacting with an intelligent chatbot to perform searches, visualize and transform sensor data, just to name a few examples. Such capabilities may be used for analysis in addition to search/visualize/transform processes described herein.

In some embodiments, a system may enable users to run their own custom sensor data transformation code. For example, a user can upload sensor data. If this data matches certain conditions (e.g., file type or tag identifier) the user can run a custom action to post-process the data, add new metadata and labels to the data, and generate new file-based artifacts (e.g., “report.pdf”). All of these could then further enhance the search experience.

Moreover, such a platform may also feature a library of common actions (e.g., sensor data transformations, downsample data, extract image frames, etc.) and users may be able to share and distribute their own actions (e.g., users may provide their own transformation code or leverage a library of common transforms, etc.). In some implementations, users may be able to describe transformations via natural language, instead of having to write their own custom transformation code. For example, a user could ask the system to generate a new action that extracts every 5th image frame from any image topics in a data file. This process may generate all of the code for an action including identifying and using third-party libraries and creating a containerized Docker image (e.g., a container image that may be a standalone, executable file used to create a container that may include source code, libraries, dependencies, tools, and other files needed to set up any required triggers, etc.).

In an embodiment, a data search method may include receiving a first dataset of measurements of a first sensor and a second dataset of measurements of a second sensor. The first dataset of measurements may span a time period that at least partially overlaps with the time period of the second dataset of measurements. For example, the first sensor may be a voltage sensor that produces a dataset of voltage measurements, which may, but need not, be a time series of values. The second sensor may measure a type of quantity the same as or different from that of the first sensor. For example, the second sensor may measure distances between two objects so that the second dataset comprises distance measurements. As for the first and second datasets, these measurements may both be in a time series.

The method may further include storing each of the first and the second datasets in a searchable format in a data repository. For example, a searchable format may be achieved by annotating or sorting elements of the datasets with timestamps, location information, or other types or combinations of metadata. The method may also include receiving a search query that identifies (e.g., names or lists) the first dataset, the second dataset, a first feature, and a second feature. In this context, a “feature” can refer to either a single value or a range of values. A feature may be an individual measurable property or characteristic of a phenomenon being observed. For example, a feature can be a specific measurement, like a temperature of 22° C. A search of a dataset may look for entries (e.g., elements) that exactly match this value. A feature can also be defined as a range, such as temperatures between 20° C. and 25° C. Searches can then be conducted to find all entries within this range. In the context of sensor data, features may include various measurements like distance, altitude, voltage, temperature, pressure, etc., and can be used to filter and retrieve data based on specific criteria set forth in a search query.

The search query, which may be performed by a system such as a computing system, may include an instruction to search for a combination of the first feature in the first dataset and the second feature in the second dataset. For example, the first feature may be one or more values or range(s) of values that are to be searched in the first dataset. Similarly, the second feature may be one or more values or range(s) of values that are to be searched in the second dataset. The search query may also include a time span during which both the first and the second features occurred. For example, a time span of one second would require the search to find the first feature occurring within one second of the occurrence of the second feature. In some implementations, a value for the time span may default to substantially zero if the time span is not specified in the search query. This default may be considered to be directed to events or measurements that occur simultaneously (e.g., within measurement, detection, and/or recording tolerances or errors).

In some implementations, as described below, the search query may further identify real-time data and a feature of the real-time data. In this case, the search query may include an additional instruction to search for the combination of the first feature in the first dataset and the second feature in the second dataset in further combination with the feature of the real-time data.

After receiving the search query, the method may further include executing, via a computing system, for example, the search query against the data repository according to the instruction in the search query and providing a search result of the search query. In some implementations, the search query may include a request for a modality of the provided search result. The modality of a search result may be graphical, numerical, textual, and visual (e.g., photos, videos), just to name a few examples.

As described below, in some implementations, the first dataset may be a time series of data generated by a non-optical sensor and the second dataset may be image-based data or point cloud-based data. Herein, a sensor that measures physical quantities like voltage, elevation, speed, and similar types of parameters, but not related to light or images, is considered to be a non-optical sensor. This term distinguishes it from sensors like cameras or photodetectors, which are designed to measure light or capture images. Non-optical sensors may be, for example, devices like voltmeters, altimeters, speedometers, and other instruments that measure various physical properties. For example, the first sensor may be a voltmeter and the first dataset may be voltages (e.g., voltage values). The second sensor may be an image sensor and the second dataset (e.g., of pixel values) may represent a photo. Accordingly, a feature of the second dataset may be an image of an object in the photo. In another example, a feature of the second dataset (which may comprise metadata for pixel values therein) may be a combination of the image of the object in the photo and a confidence score for the object. In still another example, the confidence score for the object may be separately specified in the search query as a second feature. In still another example, the second feature may be a value or a range of values for a physical parameter measured by the first sensor, which may be a non-optical sensor (e.g., a voltmeter).

In other implementations, the first dataset may be a time series of data generated by a non-optical sensor and the first feature may be a graphical shape of a user-selected portion of a plot of the time series of data. This is described in detail below.

In some embodiments, the method may further include, before storing, processing each of the first and the second datasets to index and tag the data in the first and the second datasets. The process(es) involved may be similar to or the same as those described for storing the data in a searchable format in the data repository. For example, the processing of the first and the second datasets may involve i) time synchronization by time-stamping and time-shifting (e.g., by interpolation, as needed) the first and the second datasets, ii) calculating fingerprints or feature vector embeddings for the first and the second datasets to allow for searches of complex patterns in the first and the second datasets, and/or iii) annotating the first and the second datasets with metadata or labels.

The embodiments of the data search method described above involve performing a query on features in a first dataset and a second dataset. For a data search method, alternative implementations of these embodiments may extend to performing a query on X features in Y datasets, wherein X and Y are any integers. In other words, the data search method need not be limited to two provided features for two respective datasets. For example, a query may be for three (e.g., X=3) features in two (e.g., Y=2) datasets. Moreover, alternative implementations of these embodiments may also extend to performing a query on a single feature in a single dataset. Claimed subject matter is not limited to any particular number of features and/or datasets. For example, in the case of a single dataset, a user may select a region of a graph containing a single feature of interest for searching (e.g., X=Y=1). For instance, a user may identify a spike in battery voltage data from a drone, and then select the region of the graph corresponding to the spike and initiate a search for any other occurrences of that spike in all other drone flights. Alternatively, a user may identify more complex patterns in a dataset, such as in data produced by a drone's inertial measurement unit (IMU). A hard landing event may be identified by an acceleration signal that spikes negatively and then shortly afterwards spikes positively. A user may select the region of the graph encompassing this event to find similar landing events in other flights. A further example could be finding similar sequences of step changes (e.g., stair step pattern) in electrical current data from a car's power distribution unit. Similar sequences may indicate drives where components were turned on in the same order.

Embodiments of data search methods described herein may allow for many types of searches. Some non-limiting examples are as follows. A search query to find all flights where battery current dropped below 100 amps at an altitude greater than 200 meters. A search query to find all images where a red traffic light is detected and the brake isn't engaged. A search query to find all events where no objects are detected in a front camera but the grasper (e.g., of a machine or robot) is activated. A search query to find all flights that contain detections of a helicopter at the top of a front camera with confidence greater than 90%. A search query to find all drives at night where pedestrians are detected with a confidence below 50% in a front camera. A search query to find all flights that are tagged with snow or rain that exhibit a graphical signal corresponding to a hard landing in inertial measurement data. A search query to find all runs where platform software version is 3.4.2 and rear actuator drops below 500 rpm. A search query to find all images during daytime that are tagged as overexposed while steering wheel is moving to the left. A search query to find all events where the aircraft pitot tube measures 0 pressure and altitude was greater than 10,000 ft. A search query to find all images where a marker is detected in a rear camera while vehicle is in the landing phase. A search query to find all drives where a child is detected in the center of a camera view while vehicle speed is greater than 50 mph.

Note that in the last example above, a search for “find all drives” may return locations but may instead (or also) return a set of IDs, where a single ID corresponds to a collection of datasets that represent all the data for a single drive. For example, one drive may contain datasets for battery current, steering wheel angle, etc. But this could collectively be referred to with a single “Drive ID”. Sometimes a user may want the actual matching dataset returned, but other times they may just want the “Drive ID” in which the dataset was collected. Across industries, different companies generally use different terms to refer to such data. For example, car companies may refer to Drive IDs, but drone companies may refer to Flight IDs.

In some embodiments, a method may include receiving a search query that identifies a group of images, a first object type, a second object type, and a feature of the first object type. The search query may include an instruction to search the group of images for incidences of the second object type coexisting with the first object type having the feature of the first object type. The method may also include executing the search query according to the instruction and providing a search result of the search query. The feature of the first object type may be a calculated value or range of values or may be measured by a non-optical sensor. In some examples, the feature of the first object type may be a confidence score for the first object type. In some cases, the group of images may be a time series of images (e.g., video) and the feature of the first object type may be a time series of data generated by a non-optical sensor. Moreover, the search query may include a graphical shape of a user-selected portion of a plot of the time series of data, as described below.

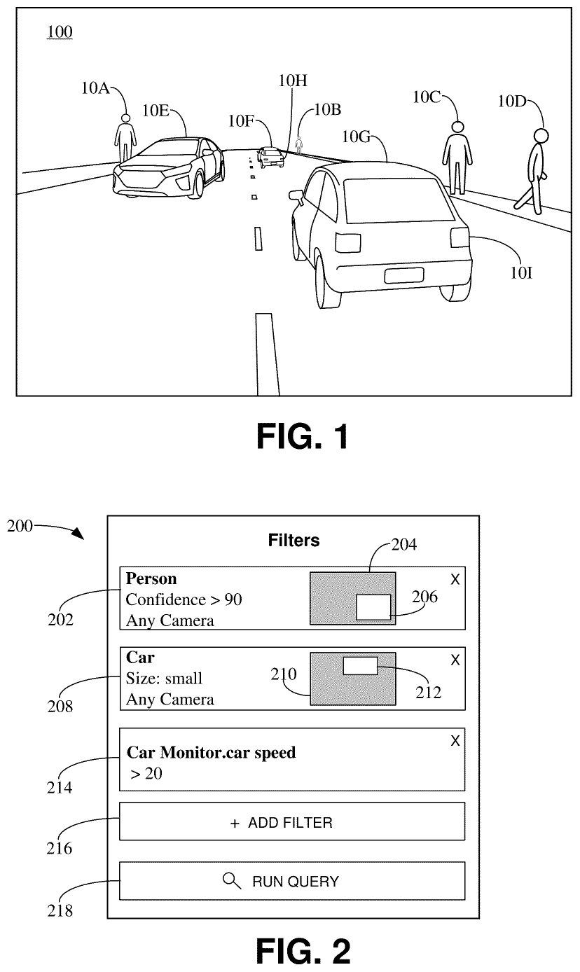

FIG. 1 is an example embodiment of sensor data comprising an image 100 that includes image objects 10A-10I, such as persons, cars, and brake lights. For example, image 100 may have been captured (e.g., taken) by a camera (e.g., an image sensor, which is herein considered to be a type of optical sensor) that may be at a fixed location or mounted on a moveable object such as a car. The camera may be (or function as) a video camera or a still camera. In this particular example, image 100 includes persons 10A-10D, cars 10E-10G, and brake lights 10H and 10I.

Object recognition may be applied to image 100, for example, to detect (e.g., “sense”) various objects, such as persons and cars and their locations or positions relative to a reference point. (Though a reference point need not be used in cases where merely the presence or absence of an object (or a feature of the object), such as a person or brake lights, in an image frame is significant.) For example, referring to FIG. 1, a processor, through object recognition and image processing of image 100, may determine that person 10C is less than a 10-degree angle from car 10G, and person 10D is greater than a 10-degree angle from car 10G and other car 10E. Moreover, image processing may provide confidence scores for the identification of each object in an image. For example, image processing may allow for identifying an object in image 100 as person 10B with a confidence score of 75% (100% is defined as 100% certainty that the object is correctly identified).

Image 100 may be among a group or set of images, such as a video, wherein other images in the group or set may include cars and persons instead of, or in addition to, the ones included in image 100. The group or set may be a time-series. A search may be performed across multiple or all of the images of the group or set of images. As applied to the group or set of images, of which image 100 is an element, a search query may identify, for example, a first dataset as being the speeds of cars and a second dataset as being the position of persons relative to the cars. The first dataset may be generated by a sensor that measures speeds of each car or may be generated by image processing that identifies cars in images and determines relative positioning (e.g., with respect to fixed objects in the image) within different images to determine the cars' speeds. The second dataset may also be generated by such image processing techniques.

The search query may further identify a third data set as being brake light activity (e.g., determined by image processing, such as measuring relative brightness of pixels). (Embodiments herein may include searches that involve one or more datasets and one or more features, and claimed subject matter is not limited in this respect.) The search query may further identify a first feature of the first dataset as being a speed that is greater than 10 meters per second (mps), a second feature of the second dataset as being 5 meters or less, and a third feature of the third data set as being “brake lights off”. The search query may further identify a fourth feature of a fourth dataset as being “the distance between each person relative to each of the cars decreasing.” For example, the fourth dataset may be generated by a process that analyses a time-sequence of two or more images, such as an image captured just before and/or just after image 100 was captured. In this way, whether a distance between a person is increasing or decreasing can be determined, and such a determination may be an element of the fourth dataset. Elements of the fourth dataset may be of only two possibilities: increasing distance or decreasing distance. These elements, like other elements of the other respective datasets, may all be aligned with one another in time by a process described above, for example.

The search query may include an instruction to search for a combination of the features in the respective datasets. For example, the instruction may be to search across all images, including image 100, for a combination of any car going faster than 10 mps (e.g., the first feature) that is 5 meters or less (e.g., the second feature) from a person when the brake lights of the car are off (e.g., the third feature). A different or subsequently augmented search may include the fourth feature wherein the car is getting closer to the person while going faster than 10 mps and closer than 5 meters to the person with the brake lights off. The search result may, using timestamps of the respective images, for example, provide time ranges for when conditions of the instruction of the search query are satisfied. The search may also provide example images of the group or set of images for when conditions of the instruction of the search query are satisfied. How search results are presented (e.g., the modality) may be specified in the search query, for example, or set as a default from a user interface of the system.

In some implementations, the search may add another feature such as a confidence score. Using the example above, the search query may include an instruction to search for the combination of any car going faster than 10 mps that is 5 meters or less from an object in the image that is identified as a person with a confidence score greater than 85%, for instance.

The search query may also include a time span during which the car was going faster than 10 mps and was 5 meters or less from a person (e.g., the first and the second features). For example, a time span of one second may lead to search results including all incidences where these conditions are met within one second of each other. Generally, a longer time span may lead to search results that include a larger number of incidences as compared to results of a shorter time span. A non-specified or zero time span may require the search to be limited to events (e.g., features) that occur simultaneously (e.g., within measurement, detection, and/or recording tolerances or errors).

FIG. 2 is an example embodiment of a data field or user interface window 200 that includes drop-down menus for user selection of parameters for a search query, such as that for the example search queries described above for FIG. 1. Window 200 includes a number of drop-down menus for selecting or filtering the parameters of a search, though claimed subject matter is not limited to such selecting or filtering via drop-down menus or other particular input methods. Window 200 may be applied to any search query but, for sake of a specific example, the search queries described above for FIG. 1 will be considered.

Drop-down menu 202 allows for a selection of attributes of a person(s) associated with one or more datasets. For example, a user may use drop-down menu 202 to filter out search results wherein the confidence score of an object of an image (in the dataset(s)) determined to be a person is 90% or less. The drop-down menu may also include a selection of one or more datasets by, in this case, selecting the camera from which the dataset is generated. The drop-down menu may also include an icon 204 or representation of images (e.g., image 100) of the dataset. Icon 204 may allow a user to select a particular portion 206, or portions, of the images. The selected portion(s) 206 may then limit the search to looking at only the selected portion(s) of each image of the database. For example, as illustrated in FIG. 2, only persons (e.g., objects representative of persons) in the lower-right portion of an image will be considered in the search. Similarly, another drop-down menu 208 allows for a selection of attributes of a car(s) associated with one or more datasets. For example, a user may use drop-down menu 208 to filter out search results wherein the size of the car is a small (e.g., a compact). The drop-down menu may also include a selection of one or more datasets by, in this case, selecting the camera from which the dataset is generated. The drop-down menu may also include an icon 210 or image representation of images (e.g., image 100) of the dataset. Icon 210 may allow a user to select a particular portion 212, or portions, of the images. The selected portion(s) 212 may then limit the search to looking at only the selected portion(s) of each image of the database. For example, as illustrated in FIG. 2, only small cars (e.g., objects representative of cars) in an upper portion of an image will be considered in the search.

Window 200 may also be used to filter the search query by the speed of the car(s). For example, window field 214 allows a user to select such a speed. Window field 216 allows a user to add additional filter criteria. Upon the satisfaction of a user, for example, the search query may be executed by selecting field (or “button”) 218.

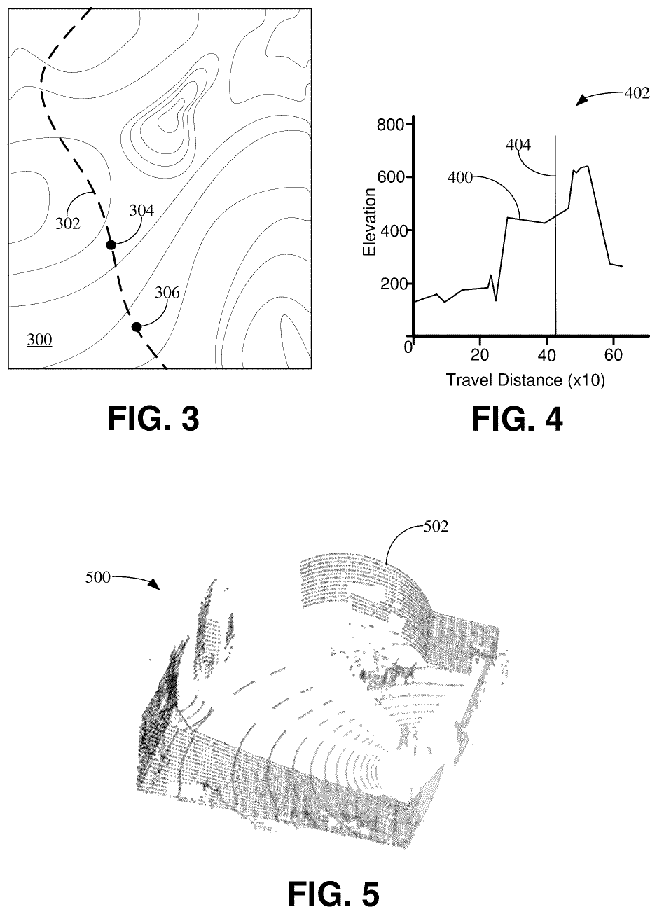

FIG. 3 illustrates geographic data on a map 300 that includes a path 302 of a drone, and FIG. 4 illustrates altitude data 400 on a graph 402 for path 302 of the drone, according to some embodiments. In other examples, a path such as path 302 may be traversed by any type of vehicle and altitude data may be recorded for any type of vehicle. Claimed subject matter is not limited in this respect. Log messages (not illustrated) corresponding to events or conditions that occur during data gathering for the flight of the drone may be saved in table form and/or annotated with timestamps that are aligned with timestamps of data collected by various sensors for the drone, for example.

A dataset of some feature of the flight of the drone (or other type of vehicle) may be represented by geographic data (e.g., path 302) on map 300, altitude data 400 on graph 402, and corresponding system logs in a table, just to name a few examples. In some implementations, clicking a geo marker on the map may resultantly show a vertical line 404 on all graphs (e.g., 402) at the corresponding timestamp and may highlight the closest log message in time. The same is true vice versa, such that selecting a log message may highlight the closest corresponding position on map 300, such as that illustrated by a dot 304. Selecting the log message may also highlight, such as by a dot 306, a portion of path 302 that corresponds to the intersection of the plot for altitude data 400 and vertical line 404. Clicking (e.g., selecting a point) on a graph may highlight the closest geo marker (e.g., dot 304 or 306) and corresponding log message.

In some implementations, a search query may be a request to search sensor data provided by complementary sensors in the same timeframe. For example, all video footage from a camera on the drone that coincided with a malfunction or event of the drone may be retrieved along with sensor data for better situational context and to form a new dataset. In a particular example, referring to FIGS. 3 and 4, the drone may experience a malfunction at a point 306 along with a particular combination of sensor data values. A search may be conducted to find the same combination of sensor data values, if they occurred, at other times along path 302.

FIG. 5 illustrates an example point cloud 500 generated from lidar measurements, according to some embodiments. As explained above, a system may classify regions of images, video frames, or 3D point clouds for computer vision (e.g., image processing, object recognition, or deep learning algorithms) and generate and assign metadata to them. Any type of object, motion queues, or tracking information of objects may be used to generate metadata that can be used for queries. In some implementations, a user may provide their own annotations on images or point clouds, or the user may upload this kind of data and have the system annotate it automatically. Point cloud data generally relates to a collection of points in N-dimensional space. Camera depth sensors or time-of-flight sensors typically produce 2D point clouds while lidars typically produce 3D point clouds. Each point 502 in point cloud 500 can have an associated distance, as well as intensity values that relate to the return strength/brightness of the beam (dependent on the surface reflecting it), in the case of lidar.

In some implementations, a search query may specify a search for an object or detection from point cloud data and/or image data. The search query may also use the distance or intensity values (when available) to constrain the results of the search query.

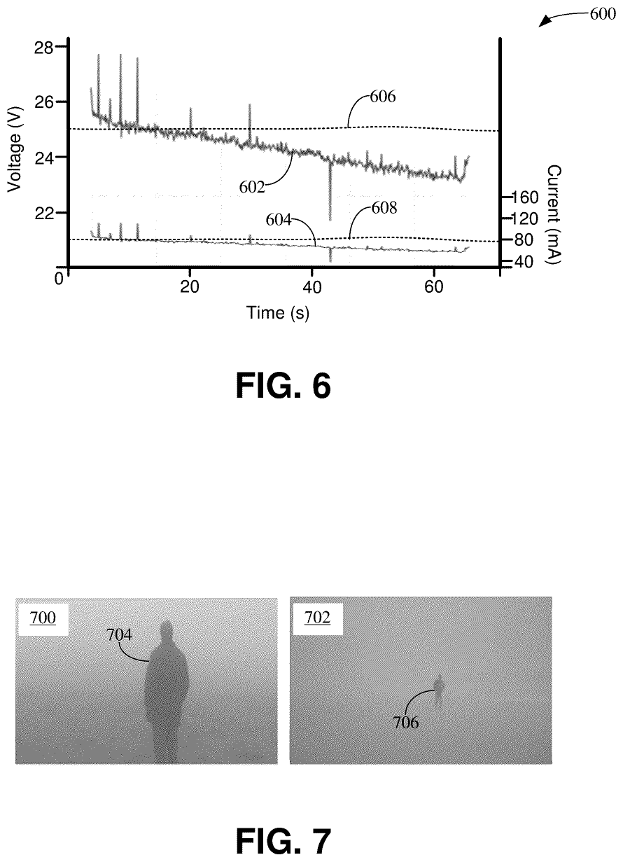

FIG. 6 illustrates non-optical data on a graph 600 that may be used with a chatbot style interface for querying sensor data, according to some embodiments. In these embodiments, a system may search and/or transform sensor data with natural language in the form of a chat (or chatbot-style) user interface. For example, the chatbot may be interactive, so a user may ask a question/query and then continue to refine or transform the results through subsequent interactions. A particular example of an interaction between a user and the system may be as follows:
System: Hello, what can I help you with today?
User: I need battery voltage data from the flight which crashed on Thursday.
System: No problem, let me get that for you.

At this stage of the interaction, the system may present to the user graph 600 including data plot 602 that represents the requested battery voltage data. The interaction may continue as follows:
User: Great thanks. Can you overlay the battery current as well? And also include average values of battery voltage and current for typical flights.
System: Sure, here you go:

At this stage of the interaction, the system may add to graph 600 data plot 604 that represents the requested battery current data and may also add plots 606 and 608 representing the requested average values of battery voltage and current for typical flights. The interaction may continue as follows:
User: Was this different to other recent flights?
System: I'll determine if there were any outliers compared to other recent flights.

At this stage of the interaction, the system may commence a search of various datasets associated with recent flights.

FIG. 7 includes images used in an example of a chatbot style user interface for querying sensor data, according to some embodiments. Similar to those described above for FIG. 6, in these embodiments, a system may search and/or transform sensor data with natural language in the form of a chat (or chatbot-style) user interface. For example, the chatbot may be interactive, so a user may ask a question/query and then continue to refine or transform the results through subsequent interactions. A particular example of an interaction between a user and the system may be as follows:
System: Hi User, what can I help you with today?
User: I need to determine how many humans we detected in the view of camera 3 during January.
System: Okay. January 1 to Jan. 31, 2022, total number of humans detected in the view of camera 3:355.
User: Okay, thanks. I'm worried that we might be missing some humans in that count.
System: Oh? Perhaps our model is not well calibrated to some conditions. Do you have any conditions in mind?
User: Yes, I'm worried about foggy conditions. The cameras don't work well in fog.
System: Let me find some detections that were borderline in foggy conditions . . . Is this what you had in mind?

At this stage of the interaction, the system may present to the user photos 700 and 702, each including an image of a person 704 and 706, respectively, in foggy conditions. The interaction may continue as follows:
User: Yes! These should have been detected as a human.

At this stage of the interaction, the system may adjust thresholds or criteria it uses for determining whether an object in an image is a person. The system may also present a new, updated count of humans in view of the new criteria.

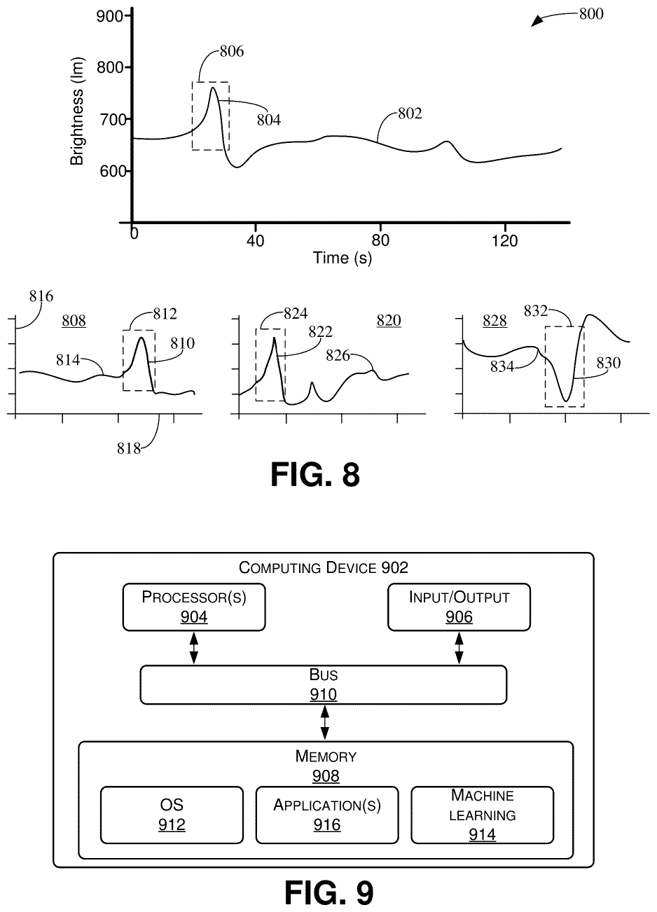

FIG. 8 illustrates a process of selecting a portion of a data plot in a graph 800 for a search query, according to some embodiments. For example, a search query may identify i) a dataset that is a time series (or another type of series) of data generated by a sensor and ii) a feature of the dataset, as specified in the search query, which may be a graphical shape of a user-selected portion of a plot of the time series of data. Referring to graph 800, data plot 802 may be a dataset for a search query, which may set forth a graphical shape 804 as a feature to be searched in the dataset (e.g., possibly in combination with features of other datasets). To present a particular example, data plot 802 may be a plot of brightness as a function of time.

In detail, graphical shape 804 may be graphically selected, for example, when a user forms a bounding box 806 to contain the desired portion of data plot 802. In other implementations, graphical shape 804 may be selected by identifying two bounding points on the (horizontal) time axis (if data plot 802 is a function such that only one value of brightness exists for each time value). Claimed subject matter is not limited to any particular technique for a selection of a graphical shape.

When executed, the search query may look through the dataset and/or other datasets for signal sequences that match the signal sequence represented by graphical shape 804. In some implementations, the other datasets may comprise elements that are of types that are different from those of the elements of the dataset (e.g., brightness versus voltage). In other implementations, the other datasets may comprise elements that are of types that are the same as those of the elements of the dataset (e.g., the other datasets comprising brightness values). The search results may be ordered by relevance and may show the matching result signal overlaid above the source signal (e.g., 804). The search results may also feature a smaller minigraph that shows where in the result signal timeline the match occurred.

In some embodiments, a search query for identifying matching graphical shapes (e.g., 804) may be based, at least in part, on parameters that may be varied by a user or other entity. The parameters may relate to various features of the graphical shape selected for the search. For example, such features may be slope(s), curvature, full-width-at-half-max (FWHM), relative heights of the endpoints, and so on. Thus, a search may be filtered by thresholds associated with such features. For example, graph 808 includes an example match for a search query looking for similarities to graphical shape 804. Features of a graphical shape 810 (illustrated within box 812) of a dataset plot 814 fall within threshold values set forth in the search query. For example, slopes near the peak of graphical shape 810 are different from those of graphical shape 804 but are within threshold values for the search. The slope differences may be considered in view of another feature of the graphical shape: the relative heights of the endpoints of graphical shape 810, which are very similar to those of graphical shape 804. In other words, one feature may be slightly non-matching and this may be countered by another feature being a particularly close match. In some implementations, the dataset of graph 808 may comprise elements that are of the same type as that of graph 800, namely brightness, in this case. In other implementations, the data type may be different. For example, graph 808 may be voltage (along vertical axis 816) as a function of time (horizontal axis 818). In some implementations, the system performing the search may adjust the vertical and/or horizontal scale of the axes (816 and 818) to match the scale of graphical shape 804.

For another example, graph 820 includes an example match for the search query looking for similarities to graphical shape 804. Features of a graphical shape 822 (illustrated within box 824) of a dataset plot 826 fall within threshold values set forth in the search query. For example, slopes near the peak of graphical shape 822 are different from those of graphical shape 804 but are within threshold values for the search. Other features, such as the relative heights of the endpoints of graphical shape 822 are similar to those of graphical shape 804.

For still another example, graph 828 includes an example match for the search query looking for similarities to graphical shape 804. Features of a graphical shape 830 (illustrated within box 832) of a dataset plot 834 fall within threshold values set forth in a search query. In this case, however, graphical shape 830 is inverted. The search query may allow for this and it may be a user-selectable parameter for the search.

FIG. 9 illustrates an example computing device 900 in which example processes described herein can operate. Computing device 902 can comprise any type of device with one or multiple processors 904 operably connected to an input/output interface 906 and memory 908, e.g., via a bus 910. Computing device 902 can include personal computers such as, for example, desktop computers, laptop computers, tablet computers, telecommunication devices, personal digital assistants (PDAs), electronic book readers, wearable computers, automotive computers, gaming devices, etc. Computing device 902 can also include devices such as, for example, server computers, thin clients, terminals, and/or work stations. In some examples, computing device 902 can include, for example, components for integration in a computing device, appliances, or other sorts of devices.

In some examples, some or all of the functionality described as being performed by computing device 902 may be implemented by one or more remote peer computing devices, a remote server or servers, or a cloud computing resource. In some examples, a computing device 902 may comprise an input port to receive a collection of sentences with syntactic dependency trees. Computing device 902 may further comprise one or multiple processors 904 to access a database that includes nested events and assign probabilities or scores to syntactic trees annotated with semantic annotations. Such assignment may be based, at least in part, on the sentences and the nested events, for example.

In some examples, one or multiple processors 904 may be configured to train a statistical model that assigns the probabilities or the scores to the syntactic trees with semantic annotations. One or multiple processors 904 may be configured to generate an event table based, at least in part, on the statistical model. The event table may comprise two or more inter-related events each categorized by type, cause, and theme, for example. One or multiple processors 904 may be configured to determine emission parameters and/or transition parameters for a joint model of (i) the syntactic trees and (ii) semantic trees by maximizing likelihoods of the syntactic trees. To take into account the information from the database, the likelihood of the semantic trees may be augmented by compatibility scores with the database that includes the nested events.

In some examples, memory 908 can store instructions executable by the processor(s) 904 including an operating system (OS) 912, a machine learning module 914, and programs or applications 916 that are loadable and executable by processor(s) 904. The one or more processors 904 may include one or more central processing units (CPUs), graphics processing units (GPUs), video buffer processors, and so on. In some implementations, machine learning module 914 comprises executable code stored in memory 908 and is executable by processor(s) 904 to collect information, locally or remotely by computing device 902, via input/output 906. The information may be associated with one or more of applications 916. Machine learning module 914 may selectively apply any of a number of machine learning decision models stored in memory 908 (or, more particularly, stored in machine learning 914) to apply to input data.

Some or all of the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In some examples, computing device 902 can be associated with a camera capable of capturing images and/or video and/or a microphone capable of capturing audio. For example, input/output module 906 can incorporate such a camera and/or microphone. Images of text, for example, may be converted to editable text and entered into a database that includes complex or nested events. Input/output module 906 may also be configured to receive various types of non-optical sensor data, signals, or information.

Audio of speech may be converted to editable text and entered into the database that includes complex or nested events. Memory 908 may include one or a combination of computer readable media.

Computer readable media may include computer storage media and/or communication media. Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media embodies computer readable instructions, data structures, program modules, or other data in a modulated data signal, such as a carrier wave, or other transmission mechanism. As defined herein, computer storage media does not include communication media. In various examples, memory 908 is an example of computer storage media storing computer-executable instructions. When executed by processor(s) 904, the computer-executable instructions configure the processor(s) to, among other things, receive one or more syntactic dependency trees, access a database that includes nested events, and generate an event table based, at least in part, on (i) the one or more syntactic dependency trees, and (ii) the nested events, wherein the generated event table includes one or more nested relationships.

In various examples, an input device of input/output (I/O) interfaces 906 can be a direct-touch input device (e.g., a touch screen), an indirect-touch device (e.g., a touch pad), an indirect input device (e.g., a mouse, keyboard, a camera or camera array, etc.), or another type of non-tactile device, such as an audio input device.

Computing device 902 may also include one or more input/output (I/O) interfaces 906 to allow the computing device 902 to communicate with other devices. Input/output (I/O) interfaces 906 can include one or more network interfaces to enable communications between computing device 902 and other networked devices such as other device(s) 902. Input/output (I/O) interfaces 906 can allow computing device 902 to communicate with other devices such as user input peripheral devices (e.g., a keyboard, a mouse, a pen, a game controller, a voice input device, a touch input device, gestural input device, and the like) and/or output peripheral devices (e.g., a display, a printer, audio speakers, a haptic output, and the like).

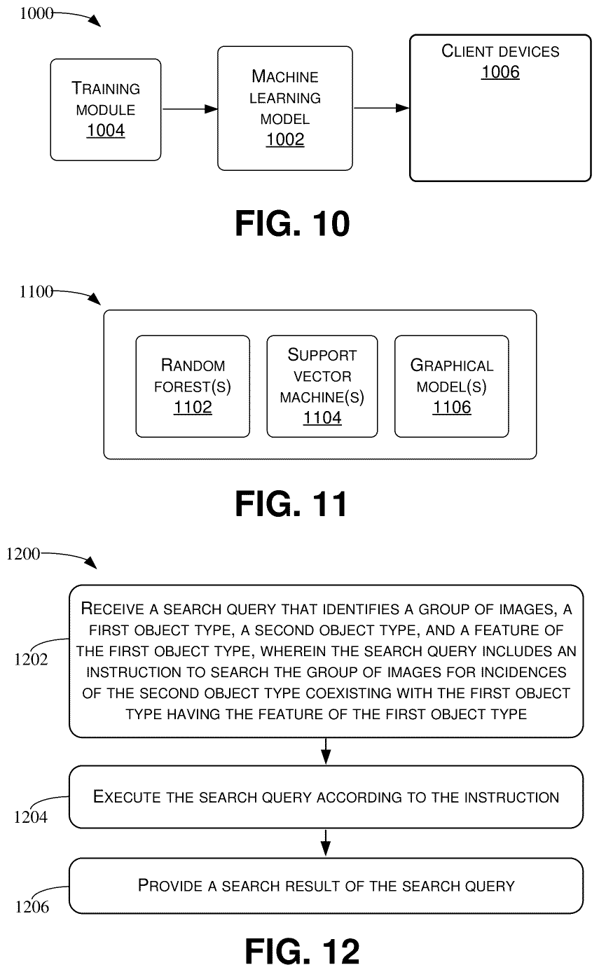

FIG. 10 is a block diagram of a machine learning system 1000, according to various examples. System 1000 may be incorporated in, or accessible to, computing device 902. System 1000 may be used for various processes described herein, such as searches among datasets for graphical shapes, object recognition in images, and so on. Machine learning system 1000 includes a machine learning model 1002, a training module 1004, and a number of client devices 1006, any of which may access one or more databases. Machine learning model 1002 may receive training data from offline training module 1004. For example, training data can include data from a population, such as a population of elements in a database. Data from the population may be used to train machine learning model 1002. Subsequent to such training, machine learning model 1002 can be employed in client devices 1006. Thus, for example, training using the data from the population for offline training can act as initial conditions for the machine learning model. Other techniques for training, such as those involving virtual evidence, described below, may be used.

FIG. 11 is a block diagram of a machine learning model 1100, according to various examples. Machine learning model 1100 may be the same as or similar to machine learning model 1002 shown in FIG. 10. Machine learning model 1100 includes any of a number of functional blocks, such as random forest block 1102, support vector machine block 1104, and graphical models block 1106. Random forest block 1102 can include an ensemble learning method for classification that operates by constructing decision trees at training time. Random forest block 1102 can output the class that is the mode of the classes output by individual trees, for example. Random forest block 1102 can function as a framework including several interchangeable parts that can be mixed and matched to create a large number of particular models. Constructing a machine learning model in such a framework involves determining directions of decisions used in each node, determining types of predictors to use in each leaf, determining splitting objectives to optimize in each node, determining methods for injecting randomness into the trees, and so on.

Support vector machine block 1104 classifies data for machine learning model 1100. Support vector machine block 1104 can function as a supervised learning model with associated learning algorithms that analyze data and recognize patterns, used for classification and regression analysis. For example, given a set of training data, each marked as belonging to one of two categories, a support vector machine training algorithm builds a machine learning model that assigns new training data into one category or the other.

Graphical models block 1106 functions as a probabilistic model for which a graph denotes conditional dependence structures between random variables. Graphical models provide algorithms for discovering and analyzing structure in distributions and extract unstructured information. Graphical models may be created through deep learning algorithms with neural network architectures. Applications of graphical models include information extraction, speech recognition, computer vision, and decoding of low-density parity-check codes, just to name a few examples.

FIG. 12 is a flow diagram of a process 1200 for a data search, according to some embodiments. The process may be performed by a computer processor (e.g., 904) executing computer-readable code, for example. In an implementation, the process of executing a search query may be performed by a system described above, such as computing system 902, for example.

At 1202, the system may receive a search query that identifies a group of images, a first object type, a second object type, and a feature of the first object type, wherein the search query includes an instruction to search the group of images for incidences of the second object type coexisting with the first object type having the feature of the first object type. At 1204, the system may execute the search query according to the instruction of the search query. At 1206, the system may provide a search result of the search query.

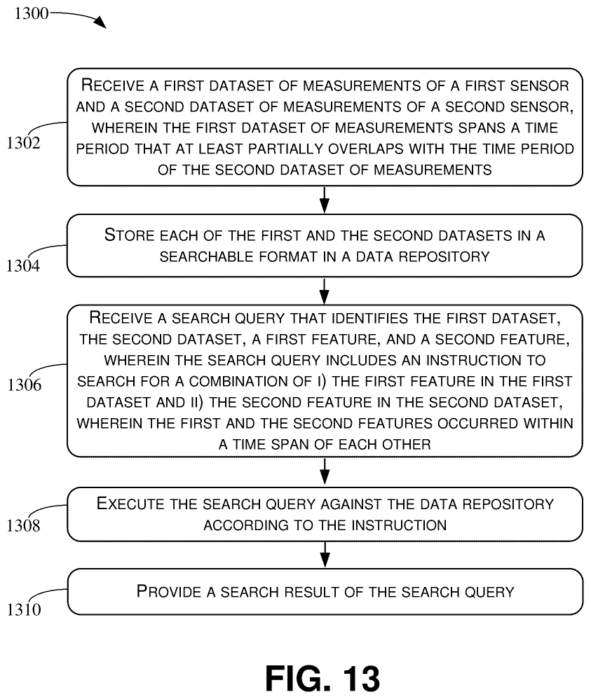

FIG. 13 is a flow diagram of a process 1300 for a data search, according to some embodiments. As for process 1200, process 1300 may be performed by a computer processor (e.g., 904) executing computer-readable code, for example. In an implementation, the process of executing a search query may be performed by a system described above, such as computing system 902, for example..

At 1302, the system may receive a first dataset of measurements of a first sensor and a second dataset of measurements of a second sensor, wherein the first dataset of measurements spans a time period that at least partially overlaps with the time period of the second dataset of measurements. At 1304, the system may store each of the first and the second datasets in a searchable format in a data repository. At 1306, the system may receive a search query that identifies the first dataset, the second dataset, a first feature, and a second feature, wherein the search query includes an instruction to search for a combination of i) the first feature in the first dataset and ii) the second feature in the second dataset, wherein the first and the second features occurred within a time span of each other. Additional datasets and features thereof may also be included in the search query. At 1308, the system may execute the search query against the data repository according to the instruction. At 1310, the system may provide a search result of the search query.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A data search method comprising:
receiving a first dataset of measurements of a first sensor and a second dataset of measurements of a second sensor, wherein the first dataset of measurements spans a time period that at least partially overlaps with the time period of the second dataset of measurements;
storing each of the first and the second datasets in a searchable format in a data repository;
receiving a search query that identifies the first dataset, the second dataset, a first feature, and a second feature, wherein the search query includes an instruction to search for a combination of i) the first feature in the first dataset and ii) the second feature in the second dataset, wherein the first and the second features occurred within a time span of each other;
executing the search query against the data repository according to the instruction; and
providing a search result of the search query.

2. The method of claim 1, wherein the first dataset is a time series of data generated by a non-optical sensor and the second dataset is image-based data or point cloud-based data.

3. The method of claim 1, wherein the first dataset is a time series of data generated by a non-optical sensor and the first feature is a graphical shape of a user-selected portion of a plot of the time series of data.

4. The method of claim 1, wherein the first sensor is an image sensor and the first dataset represents a photo.

5. The method of claim 4, wherein the first feature is an image of an object in the photo.

6. The method of claim 5, wherein the first feature is a combination of the image of the object in the photo and a confidence score for the object.

7. The method of claim 5, wherein the second feature is a confidence score for the object.

8. The method of claim 5, wherein the second feature is a value or a range of values for a physical parameter measured by the second sensor, which is a non-optical sensor.

9. The method of claim 1, further comprising receiving a value for the time span in the search query.

10. The method of claim 1, wherein a value for the time span defaults to substantially zero if the time span is not specified in the search query.

11. The method of claim 1, further comprising, before storing, processing each of the first and the second datasets to index and tag the data in the first and the second datasets, wherein the processing of the first and the second datasets involves i) time synchronization by time-stamping the first and the second datasets, ii) calculating fingerprints or feature vector embeddings for the first and the second datasets to allow for searches of complex patterns in the first and the second datasets, or iii) annotating the first and the second datasets with metadata or labels.

12. The method of claim 1, wherein the search query further includes a request for a modality of the provided search result.

13. The method of claim 1, wherein the search query further identifies real-time data and a feature of the real-time data, wherein the search query includes an additional instruction to search for the combination of the first feature in the first dataset and the second feature in the second dataset in further combination with the feature of the real-time data.

14. A method comprising:
receiving a search query that identifies a group of images, a first object type, a second object type, and a feature of the first object type, wherein the search query includes an instruction to search the group of images for incidences of the second object type coexisting with the first object type having the feature of the first object type;
executing the search query according to the instruction; and
providing a search result of the search query.

15. The method of claim 14, wherein the feature of the first object type is a calculated value or range of values or is measured by a non-optical sensor.

16. The method of claim 14, wherein the feature of the first object type is a location of the first object type in images of the group of images.

17. The method of claim 14, wherein
the group of images is a time series of images,
the feature of the first object type is a time series of data generated by a non-optical sensor, and
the search query includes a graphical shape of a user-selected portion of a plot of the time series of data.

18. The method of claim 14, wherein the search query further includes a request for a modality of the provided search result.

19. The method of claim 14, wherein the search query further identifies real-time data and a feature of the real-time data, wherein the search query includes an additional instruction to search the group of images for incidences of the second object type coexisting with the first object type having the feature of the first object type and in combination with the feature of the real-time data.

20. The method of claim 19, wherein the real-time data is generated by a non-optical sensor and the feature of the real-time data is a value or range of values of the real-time data.
